(19) United States
(12) Patent Application Publication
(10) Pub. No.: US 2009/0290688 A1
(43) Pub. Date: Nov. 26, 2009

(54) SYSTEM AND METHOD FOR SELECTIVELY CONNECTING DENIED CALLS

(75) Inventors: Richard A. Peters, Grapevine, TX (US); Bennie C. Stringer, JR., Southlake, TX (US)

Correspondence Address: FULBRIGHT & JAWORSKI L.L.P, 2200 ROSS AVENUE, SUITE 2800, DALLAS, TX, 75201-2784, US

(73) Assignee: VIXXI Solutions, Inc., Irving, TX (US)

(21) Appl. No.: 12/125,620

(22) Filed: May 22, 2008

(51) Int. Cl. H04M 11/04; H04M 3/42

(52) U.S. Cl. 379/37; 379/208.01

(57) ABSTRACT

The present invention is directed to a system and method for ensuring that calls from emergency responders and public safety answering points are connected to prepaid wireless or voice over internet protocol devices where the accounts associated with such devices have no remaining credit. According to certain embodiments of the invention a prepaid intercept is provided that enables telephone calls from certain entities to be connected to prepaid wireless devices, regardless of whether the accounts associated with such prepaid wireless devices have remaining credit. Embodiments of the present invention provide a system for determining whether an incoming call to a prepaid wireless device is from a public safety answering point and validating all calls from a public safety answering point.

### TECHNICAL FIELD

This disclosure relates generally to telephone services and, in particular, to systems and methods for selectively connecting telephone calls that would otherwise be denied.

### BACKGROUND OF THE INVENTION

Public Safety Answering Points (PSAPs) are the public's first line of contact with public safety authorities in an emergency. Dialing 911 connects a telephone user to a PSAP dispatcher trained to contact the proper emergency service or otherwise dispatch the appropriate emergency responders.

When a call is answered by a PSAP, the PSAP obtains from telephone service providers the telephone number of the telephone from which the emergency is being reported. Utilizing this telephone number, the PSAP system accesses a database containing information relating telephone numbers to names and addresses of telephone customers, and retrieves the name and billing address of the telephone customer from which the emergency call was initiated. For an emergency call originated from a fixed (i.e., landline service) telephone, the retrieved billing address information most often comprises a location address for the telephone customer, which can be used to direct emergency responders.

As the use of wireless telephones has permeated society, first responders and PSAPs have had to adapt to specific problems associated with mobile telecommunication devices. Although wireless phones are important safety tools, they create challenges for public safety personnel and wireless service providers. Because wireless phones are not associated with one fixed location or address, a caller using a wireless phone could be calling from anywhere. While the location of the cell tower used to carry a 911 call may provide a very general indication of the location of the caller, that information is not usually specific enough for rescue personnel to deliver assistance to the caller quickly. The Federal Communications Commission (FCC) has taken a number of steps to increase public safety by encouraging and coordinating development of a nationwide, seamless communications system for emergency services that includes the provision of location information for wireless 911 calls.

Additionally, the FCC has passed regulations that require wireless providers to connect outbound calls from wireless phones to PSAPs. In other words, wireless carriers are required to transmit all 911 calls to a PSAP, regardless of whether the caller subscribes to the carrier's service or not. The FCC has also mandated that wireless providers furnish requesting PSAPs with the telephone number of the originator of a wireless 911 call.

A growing number of wireless phone users are moving to prepaid or pay-as-you-go wireless services. Prepaid wireless phones operate by a user's purchase of mobile service in advance of using the service. A user's access to services is limited to an amount of prepaid credit. When a user reaches his/her prepaid credit limit, the user's service is discontinued. Prepaid wireless service raises additional challenges for public safety and wireless providers.

Specifically, problems arise when emergency service providers attempt to call a prepaid wireless user back after an emergency call from a wireless device has been disconnected. A call may be disconnected for any number of different reasons, such as an intentional hang-up by either the calling party or someone with the calling party, an accidental hang-up, or a dropped call (e.g., a faded signal). When a call to a PSAP is disconnected, PSAP guidelines require operators to call the automatic number identification (ANI), or caller identification, associated with the originating call. In instances where a PSAP operator attempts to call a prepaid phone that has reached its credit limit and has no remaining minutes the call is disallowed. In other words, PSAP operators are unable to call back prepaid wireless subscribers who have reached their credit limit. Thus, while a prepaid wireless caller who has no remaining balance is permitted to place a call to an emergency service, the prepaid wireless caller is not permitted to receive in-bound calls, even those from an emergency service.

Similar problems exist in the context of prepaid voice over Internet protocol (VoIP). The FCC has responded to the development of VoIP services by requiring that VoIP providers deliver all 911 calls to local emergency call centers (PSAPs) and deliver customer call back number and location information where the emergency call center is capable of receiving it. However, when a prepaid VoIP subscriber has reached his/her credit limit, PSAP operators are unable to re-connect with a disconnected prepaid VoIP subscriber as the subscriber is not permitted to receive in-bound calls.

Prepaid telecommunications has given rise to a substantial problem in public safety. Although all wireless and VoIP providers are required to connect outbound emergency calls from users of their services, those providers do not connect in-bound calls from emergency service providers when the users would otherwise be denied service (e.g., for failure to establish service, failure to maintain a prepaid balance on a prepaid account, or past due payment for a post-paid account, etc.).

### BRIEF SUMMARY OF THE INVENTION

The present invention is directed to systems and methods for enabling certain telephone calls to become connected where they otherwise would not be. According to certain embodiments of the invention, an intercept is provided that enables telephone calls from certain entities to be connected to telephony devices (i.e., landline devices, WiFi devices, wireless devices, or VoIP devices), regardless of whether the calls would otherwise not be connected. Embodiments of the present invention provide a system for determining whether an incoming call to a telephony device is from a predefined emergency caller, such as a public safety answering point (PSAP), and validating all calls originating from predefined emergency caller. This technique allows for selective completion of in-bound calls to an entity that would otherwise be denied in-bound call service. Denial of service may be due to failure to maintain a sufficient prepaid balance. It may also be due to other reasons, such as delinquent payment on a post-paid account or failure to activate service. The completion may be of a call from emergency responders. The completion may also be from any other authorized entity, such as designated schools, hospitals, retirement homes, or family members.

In one embodiment, an intercept enables telecommunication providers and subscribers to designate entities from which calls will always be validated. For instance, a prepaid wireless provider may designate that all calls from telephone numbers associated with schools to a particular prepaid device be validated. In other embodiments of the present invention, a prepaid intercept is provided that enables outgoing telephone calls from a prepaid telephony device to be connected to specified entities, regardless of the account balance associated with such a prepaid wireless device. These embodiments determine whether a call destination entity has been approved for validation and returns instructions indicating that a particular call should be validated.

In other embodiments, a prepaid intercept is provided that includes dynamic call validation. Dynamic call validation allows the prepaid intercept to validate incoming calls to disconnected telephony devices. Such validation might occur, for example, by prompting a payment from the calling entity. The calling entity might for example, be prompted to make a payment to connect the call by interactive voice recognition (IVR) program or a line operator.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. For example, it should be appreciated by those skilled in the art that embodiments of the present invention are not confined to particular types of telephony devices. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows a block diagram of a prior art system in which a prepaid wireless device is operable to make an emergency call to a public safety answering point;

FIG. 2 shows a block diagram of an exemplary system incorporating one embodiment of the present invention;

FIG. 3 is a representation of a database formed and accessed pursuant to operation of an embodiment of the present invention;

FIG. 4 shows an exemplary operational flow diagram for the emergency intercept of the present invention; and

FIG. 5 is an exemplary operational flow diagram for accessing an emergency intercept from a communications system.

### DETAILED DESCRIPTION OF THE INVENTION

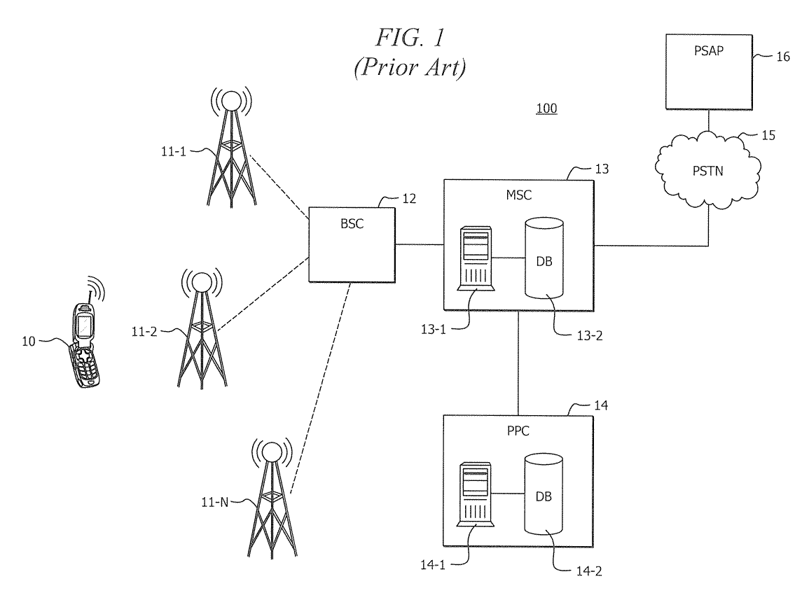

FIG. 1 is a block diagram of a prior art system in which a prepaid wireless device is operable to make an emergency call to a public safety answering point (PSAP). System 100 includes prepaid wireless device 10, base stations 11-1 through 11-n, base station controller (BSC) 12, network subsystem 13, prepaid provider center (PPC) 14, public switched telephone network (PSTN) 15, and PSAP 16. The following discussion describes traditional handling of an emergency call from prepaid wireless device 10 to PSAP 16 within prior art system 100 and the shortfalls of emergency call back in such systems.

When a prepaid subscriber dials 911 for emergency services using prepaid wireless device 10, prepaid wireless device 10 transmits a dialed number identification service (DNIS) and automatic number identification (ANI) to a base transceiver station (e.g., base transceiver station 11-2), which receives and transmits radio signals to prepaid wireless device 10. BSC 12 controls the receipt and transmission of radio signals at base stations 11-1 through 11-n and facilitates communication between mobile units (e.g., prepaid wireless device 10) and network subsystem 13. In the present example, BSC 12 communicates the DNIS and ANI transmitted, via base transceiver station 11-2, from the prepaid wireless device 10 to network subsystem 13.

Network subsystem 13 includes mobile switching center (MSC) 13-1 and public safety answering point database (PSAPDB) 13-2. MSC 13-1 may comprise a number of known communication switching devices, including those known by one skilled in the art for providing cellular telephone services to prepaid wireless device 10. MSC 13-1 performs switching functions to permit communication between prepaid wireless device 10 and PSTN 15. Based on the DNIS communicated to network subsystem 13 from prepaid wireless device 10 through BSC 12, MSC 13-1 selects an appropriate PSAP from PSAPDB 13-2 and routes the emergency call from prepaid wireless device 10 through PSTN 15 to PSAP 16. When the emergency call from prepaid wireless device 10 is received by PSAP 16, PSAP 16 receives, among other data, the ANI of prepaid wireless device 10.

For purposes of illustrating the shortfalls of the prior art, assume that the connection between prepaid wireless device 10 and PSAP 16 becomes disconnected. The connection might be lost for any number of reasons, including loss of signal strength, accidental hang up, or failure of a system component, as examples. Typical PSAP operating procedures require PSAP operators to initiate a call back when an emergency call is disconnected. Thus, in the present example, an operator at PSAP 16 initiates a call back to prepaid wireless device 10 using the ANI for prepaid wireless device 10.

The call back from PSAP 16 is routed to network subsystem 13 and MSC 13-1. Before connecting the in-bound call to prepaid wireless device 10, MSC 13-1 requests validation from PPC 14. PPC 14 comprises a prepaid provider server 14-1 and a prepaid account database 14-2. The prepaid account database 14-2 stores information related to prepaid wireless user's account balances and services. Prepaid account database 14-2 may also store subscriber identification, credit card information, or other specific information related to an account. Prepaid provider server 14-1 administers and updates prepaid account database 14-2 in a manner well-known by those skilled in the art.

Prepaid provider server 14-1 receives the validation request from MSC 13-1 and queries prepaid provider database 14-2 to determine whether the prepaid account associated with prepaid wireless device 10 has sufficient credit remaining to receive an inbound call. If server 14-1 determines that the account has sufficient credit remaining, prepaid provider server 14-1 communicates a signal to MSC 13-1 indicating that the call should be connected. In the event the account associated with prepaid wireless device 10 has insufficient credit remaining, however, prepaid provider server 14-1 communicates a signal to MSC 13-1 indicating that the call should not be connected. Thus, in the traditional system shown in FIG. 1, a call back from PSAP 16 can not be completed when the account associated with prepaid wireless device 10 has no remaining credit balance on the prepaid account.

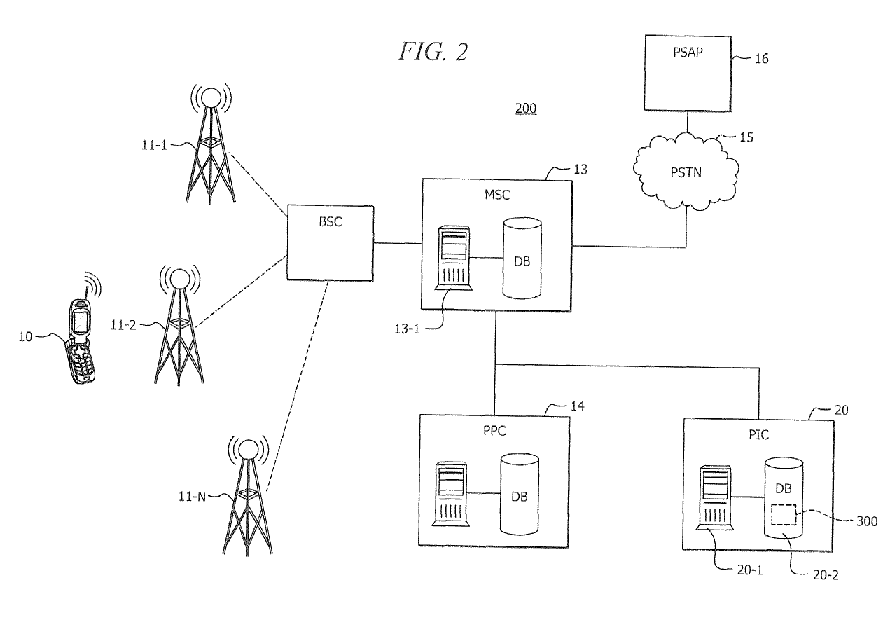

Turning now to FIG. 2, a block diagram of an exemplary system 200 according to one embodiment of the present invention is shown. System 200 includes the above-described elements of a prepaid wireless telecommunications system shown by FIG. 1 but also including prepaid intercept controller 20 in communication with network subsystem 13. As with the above example of FIG. 1, prepaid wireless communication system 200 is operable to connect prepaid wireless device 10 to PSAP 16. According to this exemplary embodiment, a user interacts with prepaid wireless device 10 to contact emergency services. System 200 may connect prepaid wireless device 10 to PSAP 16 in the manner described above for traditional system 100 (shown in FIG. 1). For purposes of illustrating the present invention, assume that the connection between prepaid wireless device 10 and PSAP 16 is disconnected.

As discussed above, normal PSAP operating procedures require PSAP operators to initiate a callback when a received call is disconnected. The operation of prepaid intercept controller (PIC) 20 will now be described in the context of an emergency callback in system 200. For purposes of this example, assume that the account associated with prepaid wireless device 10 has no remaining credit. In other words, prepaid wireless device 10 does not qualify for receiving incoming calls and, thus, in the prior art system 100 of FIG. 1 an inbound call from PSAP 16 would be denied.

When the emergency connection between prepaid wireless device 10 and PSAP 16 is lost, PSAP 16 initiates a call back to the ANI number associated with prepaid wireless device 10. The callback from PSAP 16 is directed by public switched telephone network (PSTN) 15 to mobile switching center (MS C) 13-1. As discussed above, with reference to FIG. 1, traditional system 100 would disconnect the call at this point because the account associated with prepaid wireless device 10 has no remaining credit. In system 200, however, MSC 13-1 communicates with PIC 20 to determine whether the emergency call back from PSAP 16 to prepaid wireless device 10 should be connected. When MSC 13-1 receives a response from PPC 14 that prepaid wireless device 10 has a zero account balance, MSC 13-1 sends a request to PIC 20. The request includes, at least, an identification of the caller (PSAP 16 in this example). PIC 20 processes the request and communicates a response to MSC 13-1 indicating whether the call should be connected.

In one embodiment of the present invention, MSC 13-1 requests an override validation determination from PIC 20. In this embodiment, the validation request includes the ANI number of the calling entity. PIC 20, in this embodiment, comprises a prepaid intercept server 20-1 and a prepaid intercept database 20-2. Prepaid intercept server 20-1 is operable to receive a validation request from MSC 13-1, query prepaid intercept database 20-2, and formulate and communicate a response to MSC 13-1.

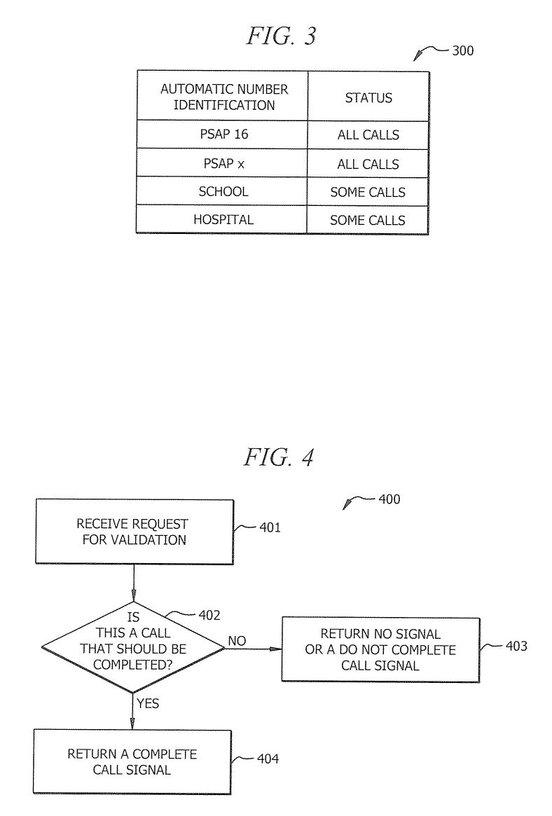

FIG. 3 illustrates exemplary records 300 stored in prepaid intercept database 20-2 (shown in FIG. 2) according to one embodiment. Each database record stored in prepaid intercept database 20-2 contains fields for an identifier, such as an automated number identification (ANI), and a status field. In the exemplary database of FIG. 3, each identifier is associated with a particular calling entity, such as a PSAP (shown in FIG. 2). The status field signifies whether calls from the identified entity should be connected, regardless of the destination device's prepaid account balance. In the present example, the ANI numbers associated with PSAPs are stored in the prepaid intercept database 20-2 and the status for each PSAP is “validate” or “connect.” Also, the validation for some situations might be both called and calling party specific. For instance, a parent might pay a fee so that call from a school or day care are always connected to the parent's prepaid device. In this scenario calls between the predefined matched pair (the parent and school for example) are connected regardless of the parent's account status. These situations might be limited by certain parameters such as calling time or call duration, which might require extra fields to be added to database 300. For example validation of calls between a school and a parent's prepaid device might be limited to times when school is in session.

If prepaid intercept server 20-1 queries prepaid intercept database 20-2 and determines that an incoming call should be validated, prepaid intercept server 20-1 returns a response to MSC 13-1 indicating that the incoming call should be validated and connected. If, on the other hand, prepaid intercept server 20-1 determines that the call should not be validated, prepaid intercept server 20-1 returns a response to MSC 13-1 indicating that the call should be invalidated, or disconnected.

Even though PIC 20 is shown in communication with network subsystem 13, PIC 20 could also be in communication with PPC 14. In such an embodiment, PPC 14 would send a request to PIC 20 to determine whether a call should be validated. Such a request may be sent in response to PPC 14 determining that insufficient credit exists for the called party to receive an inbound call. Alternatively, PIC 20 might be implemented within PPC 14 or network subsystem 13. In such an embodiment, PIC 20 could be deployed as separate hardware components or software within preexisting hardware components, as an example.

Prepaid intercept database 20-2 can also contain identification information related to emergency callers other than PSAPs. For example, prepaid intercept database 20-2 can contain information related to a school or daycare. In these situations, calls from a school listed in prepaid intercept database 20-2 would be connected to prepaid wireless device 10 regardless of the account balance associated with the device. This would allow, for example, a school or daycare to contact a parent in the event of an emergency. Additionally, a business might pay a fee to a service provider to include their identification information in prepaid intercept database 20-2 to ensure that its calls are always connected. Note that there may be limits imposed on calls where time and/or duration of calls may be a factor, in order to avoid abuse of the system.

System 200, illustrated by FIG. 2, might also enable outgoing calls when an account associated with prepaid wireless device 10 has a zero balance. This feature might be useful, for example, when a parent purchases a prepaid wireless device for a child. There may arise instances where the account associated with the prepaid wireless device has no remaining credit, but the child needs to call his parents. In prior art prepaid systems, the child would be unable to call his parents using the prepaid wireless device. Using the prepaid intercept of the present invention, however, parents can ensure that their children are always able to reach them. For example, prepaid service providers can allow, free or for a fee, all calls to a particular entity to be connected.

Referring to FIG. 2, PIC 20 will now be discussed in the context of ensuring that calls from prepaid wireless devices to certain entities are always connected. For purposes of describing this embodiment of the present invention, assume that a user of prepaid wireless device 10 is a child attempting to contact his parents in an emergency and that the account associated with prepaid wireless device 10 has no remaining credit. Also, assume that prepaid intercept database 20-2 is populated with information that identifies particular entities in a telecommunications network, such as DNIS.

When the user of prepaid wireless device 10 attempts to contact his/her parents, PPC 14 communicates to MSC 13-1 that the call should not be connected. Rather than disconnecting the call at this point, MSC 13-1 requests validation from PIC 20. The validation request includes call destination identification information such as a DNIS. Prepaid intercept server 20-1 queries prepaid intercept database 20-2 to determine whether the destination identification associated with the request is a preapproved entity. If the call destination identification associated with the request is approved, then prepaid intercept server 20-1 returns a validate command to MSC 13-1 and MSC 13-1 connects the call firm prepaid wireless device 10. In this manner, the prepaid intercept can be employed to ensure that calls from prepaid wireless devices to certain entities are always allowed.

In certain embodiments, PIC 20 can be implemented such that it provides dynamic call validation. In one embodiment, dynamic call validation is provided by interactive voice response (IVR) software installed and executed by prepaid intercept server 20-1. In this embodiment an incoming call that would otherwise be denied is routed to prepaid intercept server 20-1 and an IVR call flow is executed, prompting the calling entity to make a payment in order to connect the call. If the calling entity makes a payment then a validation signal is returned to MSC 13-1 and the call, which would otherwise be denied, is connected by MSC 13-1. If the calling entity does not make a payment then prepaid intercept server 20-1 does not return a validation signal and MSC 13-1 disconnects the call. Persons of ordinary skill in the art will appreciate that dynamic call validation is not limited to an IVR call flow executed by a prepaid intercept server. Dynamic call validation might also, for example, be provided by a live operator working within PIC 20. Additionally, dynamic call validation is not limited to one-time connections. In certain embodiments, prepaid intercept database 20-2 can be dynamically updated. For example, in certain embodiments, PIC 20 allows a calling entity to update the prepaid intercept database 20-2 in real time.

Although the operation of PIC 20 was discussed in the context of a prepaid wireless telecommunication system, the prepaid intercept can be employed in any communication network and used with any telephony device including, but not limited to landline, wire line, WiFi, wireless, and VoIP devices. Further, the intercept is not limited to prepaid communication systems. For example, the prepaid intercept can be employed to ensure emergency callback of telephony devices in pre-paid, post-paid/credit based, or pay-as-you-go networks that have been disconnected. Additionally, the intercept is not limited in application to call denials based on insufficient funds or credit. The intercept can be used to ensure callback of a number that is disconnected for any reason. It should be noted that the logic described for performing the operations of a prepaid intercept may be implemented as software stored to a computer-readable medium and executable by a processor based system.

FIG. 4 illustrates an exemplary operational flow diagram 400 for an emergency intercept according to one embodiment of the present invention. Process 401 receives an emergency intercept request from a telecommunications service provider. For instance, in the example of FIG. 2, PIC 20 receives a request from network subsystem 13. The request received by the emergency intercept includes information related to the identification of a caller in a telecommunications network.

Process 402 determines whether a particular call should be validated. In the example of FIG. 2, the prepaid intercept server 20-1 searches prepaid intercept database 20-2 for identification information included in the request from service provider received at operational block 401 of FIG. 4. If the database record identified by prepaid intercept server 20-1 and prepaid intercept database 20-2 of FIG. 4 indicates that a particular call should be validated (i.e., allowed or connected), process 404 prepares a response to the request indicating whether a particular call should be validated. If the call should not be connected, process 403 responds. There might also be a response called, “indeterminate” when the system does not know one way or another. This could be used to access another database (not shown) to help make the determination.

At operational block 403, the public safety intercept returns a response based on the determination at operational block 402. In the example of FIG. 2, the prepaid intercept server 20-1 returns a response to MSC 13-1. The response includes information that indicates the call should be invalidated (i.e., that the call should not be connected).

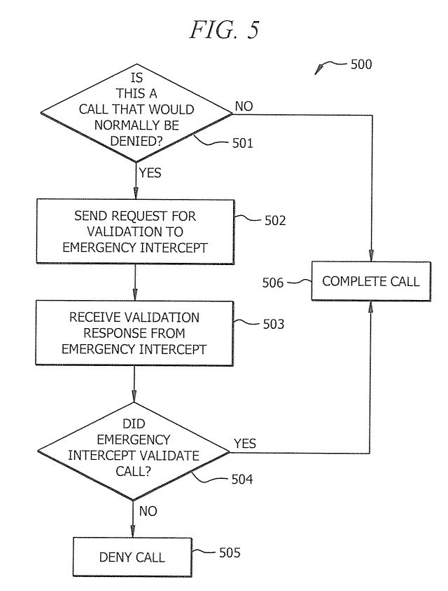

FIG. 5 provides an exemplary operational flow diagram 500 of a communications service provider requesting service from a public safety intercept. Process 501 determines whether a call should be allowed. For instance, in the above example of FIG. 2, MSC 13-1 receives an account validity communication from PPC 14. If process 501 determines that a prepaid account has sufficient credit, process 506 validates/completes the call. If process 501 determines that a prepaid account has insufficient credit, process 502 sends a request for validation to the public safety intercept. The request might include, for example, information identifying a calling entity. The public safety intercept determines whether the particular call should be validated. For instance, in the example of FIG. 2, a prepaid intercept server 20-1 queries a prepaid intercept database 20-2 to determine whether a call from a particular phone number should be authorized. If, for example, the number identifies a PSAP that relates to an entry in prepaid intercept database 20-2, then prepaid intercept will generate a validate signal and communicate the validate command to the prepaid service provider.

Process 503 receives a response from the emergency intercept. In the example of FIG. 2, prepaid intercept server 20-1 communicates a valid/invalid command to MSC 13-1. Process 504 determines whether the emergency intercept validated the call. If process 504 determines that the call should be validated, process 506 completes the call. For instance, in the example of FIG. 2, MSC 13-1 completes the requested call. If process 504 determines that the emergency intercept invalidated the call, process 505 denies the call. In the Example of FIG. 2, MSC 13-1 disconnects the requested call.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A telecommunication system comprising:
circuitry for completing calls from a calling party to a called party number in accordance with validation instructions based upon a current status of said called party number; and
validation circuitry operative in response to a call denial completion validation directed to a specific called number from a specific calling number for overriding said call denial based at least in part on an identity of said specific calling party.

2. The system of claim 1 wherein said overriding is based at least in part on an identity of said called number.

3. The system of claim 1 wherein said call denial is based, at least in part, on a lack of funds for validating a completion to said specific called number.

4. The system of claim 3 wherein said specific calling number is associated with a predefined emergency caller.

5. The system of claim 1 wherein said overriding is based at least in part on a dynamic call validation.

6. The system of claim 2 wherein said specific called number and said specific calling number are a predefined matched pair.

7. A method for completing calls in a communications system that would otherwise be denied, said method comprising:
receiving an incoming call request to connect a calling entity in said communications network to a called entity in said communications network;
ascertaining that the call should be denied;
generating an override request to a controller; and
completing said call to said called entity based upon an override from said controller.

8. The method of claim 7 wherein said request includes said identity of said calling entity, and said override is based, at least in part, on an identity of said calling.

9. The method of claim 8 wherein said incoming call request is denied because an account associated with said called entity has insufficient funds for validating completion.

10. The method of claim 9 wherein said calling entity is associated with a predefined emergency caller.

11. The method of claim 7 wherein said override is based at least in part on dynamic call validation.

12. A method for determining whether denied calls in a communications system should be completed, said method comprising:
receiving an override request from an element in a communications system, said request generated in response to a denied call to a specific called number from a specific calling number;
determining whether said denied call should be overridden based, at least in part, on an identity of said specific calling number; and
communicating a response to said override request based on said determining.

13. The method of claim 12 wherein said determining is based on information transmitted with said override request and information stored in a data storage device.

14. The method of claim 12 wherein said denied call completion is based, at least in part, on a lack of funds for validating a completion to said specific called number.

15. The method of claim 14 wherein said specific called number is associated with a prepaid account.

16. The method of claim 12 wherein said specific calling number is associated with a predefined emergency caller.

17. The method of claim 12 wherein said specific calling number is associated with a PSAP.

18. The method of claim 12 wherein said specific calling number and said specific called number are a predefined matched pair.

19. The method of claim 12 wherein said element in said communications system is a switching device.

20. The method of claim 12 wherein said element in said communications system is a prepaid account controller.

21. Computer-executable software code stored to a computer-readable medium, which when executed by a computer causes said computer to perform a method comprising:
receiving an override request, said request generated in response to a denied call to a specific called number from a specific calling number;
determining whether said denied call should be overridden based, at least in part, on an identity of said specific calling number; and
communicating a response to said override request, wherein said response is based on said determining.

22. The method of claim 21 wherein said call denial is based, at least in part, on a lack of funds for validating a call completion.

23. The method of claim 21 wherein said specific calling number is associated with a predefined emergency caller.

24. The method of claim 21 wherein said specific calling number is associated with a PSAP.

25. The method of claim 21 wherein said specific called number and said specific calling number are a predefined matched pair.
